(19) United States
(12) Patent Application Publication
(10) Pub. No.: US 2003/0028877 A1
(43) Pub. Date: Feb. 6, 2003

(54) Entertainment schedule adapter

(75) Inventors: Timothy J. Everett, Thaneham (GB); Graham G. Thomason, Redhill (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/199,052

(22) Filed: Jul. 19, 2002

(30) Foreign Application Priority Data
Jul. 31, 2001 (GB) 0118575.0

(51) Int. Cl. G06F 3/00; H04N 5/445; G06F 13/00

(52) U.S. Cl. 725/39; 725/37; 725/56

(57) ABSTRACT

A method and apparatus are described for adapting an entertainment schedule comprising a plurality of programme items. During the execution of the schedule, unforeseen conditions as represented by conditions data (106) may occur causing the data processor (101) to adapt the remaining portion of the schedule. The data processor co-operates with a tuner (118), a library server (120) and a timeshifter (122) to execute the adapted schedule. The timeshifter adjusts specified programme items received from the tuner (118) and library server (120) in conjunction with timeshifter storage (126) thereby ensuring a sequence of programme items are output at (128), the sequence comprising substantially the same material as contained in the original schedule prior to the occurrence of the condition.

### FIELD OF INVENTION

The present invention relates to a method for adapting an entertainment schedule which is executing, the schedule comprising a plurality of programme items, and also to an apparatus employing such a method.

### BACKGROUND TO INVENTION

Traditionally a user has organised an evening's home entertainment around a schedule of pre-selected broadcast and pre-recorded library items. Methods to define and organise the schedule are many and varied ranging from the simplest case where a user takes the scheduled offerings of one or more broadcasters to more sophisticated automated schemes perhaps involving Electronic Programme Guides (EPG) combined with timeshifting capability, for example as disclosed in commonly assigned patent application EP1057330. The result of all the above methods is the creation of a planned schedule or running order of items spanning a time interval or session.

Problems can arise in the execution of a planned schedule. A schedule which includes broadcast programme items to be presented at the time of broadcast relies on these items commencing on time (that is, in accordance with the published scheduled start time) and also running to time (that is, in accordance with the published scheduled duration).

A further problem arises where a broadcaster experiences an unforeseen technical difficulty resulting in an interruption to a programme item currently being broadcast.

From a user's perspective, planned schedules are constraining. In the past, without the capability to record and timeshift programme items, it was essential for a user to access the item at the time it was broadcast, else miss the item altogether. With recording capability a user can postpone access to a broadcast item provided notice is given prior to the item being broadcast so as to arrange the recording of the item. A problem arises where a user is expecting to access an item ‘live’ when broadcast (that is, without arranging in advance to record the item) but unforeseen circumstances, such as a telephone interruption, at the time of broadcast make this impossible. A known solution is to timeshift the entire remaining portion of the schedule so that all remaining items are available as and when the user is able to access them. An example of a suitable timeshifting method can be found in commonly assigned patent EP-A-0594241. However, such solutions are limited, for example in terms of ordering items in the remaining portion of the schedule and the amount of timeshift storage potentially required.

A further problem with a schedule which is rigidly executed according to a pre-determined plan is the inability of a user to cancel the item currently presented. Similarly, there may be a need to extend an item beyond its original allotted end time—for example to accommodate a broadcast programme item which overruns.

Within the schedule there may be specified an event which is effectively fixed with respect to real time, for example a meal break or a live football game. The scheduling of such items needs to be preserved within a schedule which is adapted to accommodate unforeseen circumstances such as those described above.

### OBJECT OF INVENTION

It is accordingly an object of the invention to overcome these and other problems by use of an improved method and apparatus to adapt an entertainment schedule which is executing, the schedule comprising a plurality of programme items.

### SUMMARY OF INVENTION

In accordance with the present invention there is provided a method for adapting an entertainment schedule which is executing, the schedule comprising a plurality of programme items, the method being supported by means for timeshifting, wherein when a condition occurs which affects the presentation of a currently presented programme item, the remaining portion of the schedule is adapted by timeshifting at least one programme item so as to comprise substantially the same material as present in the schedule prior to the occurrance of the condition.

The method is applicable to any schedule created and intended for entertainment purposes and comprising a sequence of broadcast and pre-stored programme items accessed via broadcast and library sources respectively. As such, programme items may comprise different constructions and offer different entertainment experiences including by way of example, films, TV shows, audio tracks, internet applications, internet services and games. As can be seen, a programme item may be composed of any combination of video, audio, graphics and text components, each of said components being encoded in any combination of analogue and digital formats. A programme item as described herein may also comprise a predetermined period during which no presentation is made to a user, for example to act as a placeholder within the schedule for an non-entertainment activity such as a meal-break; a programme item may also be fixed so that timeshifting such an item in response to a condition is not permitted, that is the item has a start time and an end time after adaptation of the schedule which are the same as those of the same item prior to the occurrance of the condition.

Also in accordance with the present invention there is provided an apparatus arranged to adapt an entertainment schedule which is executing and which comprises a plurality of programme items, the portion of the schedule remaining to be executed being adaptable by the apparatus to accommodate changes due to a condition affecting the presentation of a currently presented programme item, the apparatus comprising:

a data processor comprising CPU, storage for the schedule adaptation program and the schedule, operable to process data representing the condition, to adapt the schedule and to store the adapted schedule;

a source of programme material arranged to capture and deliver programme items to a timeshifter in response to the adapted schedule; and

the timeshifter co-operating with the data processor and arranged to receive the programme items, to adjust the programme items by timeshifting and to output the programme items in a sequence in accordance with the adapted schedule.

The data processor may be conventional and preferably includes nonvolatile memory to store the schedule.

The source of programme material may include a tuner and a library server. The tuner may be capable of receiving broadcast programme items via any delivery methods including, by way of example, but not limited to terrestrial, cable, satellite, PSTN, ISDN and wireless. The library server may be situated locally or remotely with respect to the user. The server may have access to programme items pre-stored on a range of read-only and write-read media including, by way of example, but not limited to VHS, DVD, audio cassette, audio CD, MiniDisc and hard diskdrive (HDD); the server may alternatively or in addition access material using on-demand and near on-demand services, as discussed later.

The timeshifter may have the ability in response to instructions from the data processor, to accept programme items from the tuner and the library server, to adjust specified items, or remnants thereof, in terms of starting time and duration and to output the items in the required sequence in accordance with the adapted remaining portion of the schedule. The adapted remaining portion of the schedule may also provide contiguity in the presentation of programme items.

### BRIEF DESCRIPTION OF DRAWINGS

Further features and advantages will now be described, by way of example only, with reference to the accompanying drawings in which:

FIG. 1 is a schematic representation of the adaptation apparatus;

FIGS. 2-6 are various examples of conditions and corresponding adaptations to the remaining portion of a schedule in accordance with the present invention.

FIG. 7 is a flow diagram of the method according to the invention.

### DETAILED DESCRIPTION

Within the following description of the present invention the term ‘an entertainment schedule’ is also referred to as a ‘schedule’. The means to adapt the schedule is also referred to as a ‘adapter’ or ‘adaptation apparatus’. The term ‘programme item’ refers to an entity which can be included within a schedule and is characterised by a start time and a duration (or end time); a programme item may or may not include programme material; a programme item may also refer to a remnant of a programme item. The term ‘timeshifting’ refers to any combination of adjustment to the starting time and duration of a programme item for the purpose of including said item within an adapted schedule. The term ‘contiguous’ is used to refer to the sequence of programme items within a schedule, wherein the end time instant of a programme time is coincident with the start time instant of the immediately following programme item. The term ‘executing schedule’ denotes the situation whereby a schedule created at an earlier time is currently executing so as to present to the user the sequence of programme items as determined by the schedule. The term ‘programme skip’ or ‘skip’ refers to the situation whereby a user elects not to access, for example not to view and/or listen to, the remainder of the current programme item in an executing schedule. The term ‘metadata’ refers to information or auxiliary data which is associated with, but separate from, a programme item and is intended as an option, to enhance or adjust the programme item and/or cause the adapter to perform contingency actions.

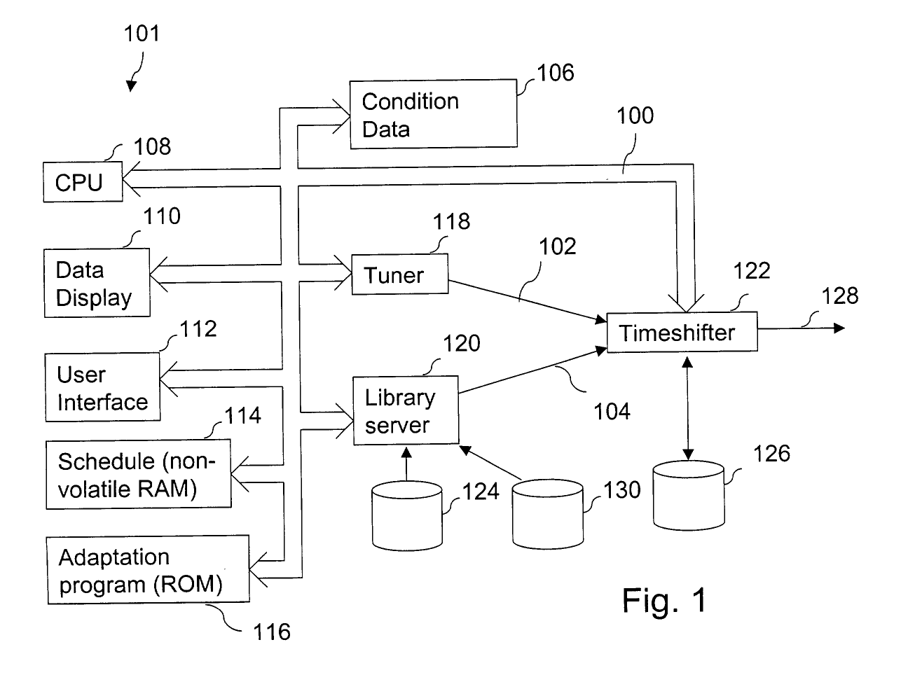

FIG. 1 shows the apparatus for the adapter comprising generally at the left hand side the data processor 101 comprising CPU 108, non-volatile RAM memory 114 and ROM memory 116, all interconnected and co-operating by means of bus 100 with data display 110 and user interface 112. Clearly, this is one example of similar data processing arrangements available to a person skilled in the art and which is capable of the data processing tasks described herein. Conditions can occur during the execution of a schedule which affect the presentation of the current programme item. During the execution of a schedule, the data processor 101 performs adaptations to the remaining portion of the schedule in accordance with data relating to conditions 106.

In general the effects of such conditions are either to bring forward (that is, cause to be earlier) or delay (that is, cause to be later) the end time of the currently presented programme item with respect to the original planned schedule. Examples of typical conditions in relation to the current programme item include, but are not limited to, a delay in commencement, an interruption, an overrun and a programme skip. Such conditions may be invoked by users or broadcasters and usually occur without prior notice. It may be an aim of the adapter that, following an occurrence of a condition, the remaining portion of the schedule is arranged to complete as early as possible whilst comprising substantially the same material as present in the original planned schedule. Alternatively, the adapter may automatically organise the remaining portion of the schedule according to preferences received from the user, for example to give priority to broadcast programmes (thereby avoiding accumulating stored material).

Data relating to conditions 106 may comprise implicit and explicit data originating from programme sources and the user. Examples of implicit data include the conditions where an item is not available at the scheduled time (for example a programme item source failure) and where there is no user response (for example the user is absent).

Clearly, more robust system performance results when explicit condition data is available. One example is where the execution of the schedule is interrupted due to the non-availability of one or more resources necessary to present the schedule, for example where the TV display is already being used for another purpose or perhaps where a tuner is not available to receive a broadcast programme to be currently presented. Adaptation of the remaining portion of the schedule caused by such circumstances can be avoided where there are alternative resources available, for example picture-in-picture capability on the TV, a second TV, a second tuner, etc.

For broadcast material, explicit condition data may be delivered as auxiliary data (metadata) associated with a programme item. A current example being Programme Delivery Control data which is capable of signalling in real-time the commencement, presentation, interruption, cessation and even cancellation of a programme item to which it relates. It will be readily appreciated by persons skilled in the art that alternative methods are also available or may be defined. Furthermore, metadata may also qualify a programme item in terms of its relation to a series of programme items, such data being termed herein as programme item identification information. The timeshifting of a programme item, in response to a condition occurring, may be influenced according to programme item identification information associated with the programme item, for example to correctly order programme items belonging to a series within the adapted remaining portion of the schedule. Delivery of metadata may be via any convenient means including, but not limited to, terrestrial, cable, satellite and the Internet. Timeshifting of a programme item may be performed in response to auxiliary data (metadata) which is associated with the item, such as that described above.

Explicit condition data available from a user implies a user signalling various ‘states’ and ‘instructions’ in relation to the presentation of the current programme item. As examples, states might include ‘user present’ and ‘user absent’; instructions might include ‘skip’, ‘pause’ (interrupt), ‘start’ and ‘stop’. Any means available to the user may be employed as a signalling means including: switches, infrared remote control, etc.

When a schedule is executed the data processor instructs the tuner 118, library server 120 and timeshifter 122 respectively in accordance with the schedule. The tuner accesses broadcast material and delivers said material 102 to the timeshifter. The library server accesses storage 124 containing prerecorded material, or accesses on-demand material 130 and delivers said material 104 to the timeshifter. In response to conditions (expressed by condition data 106) affecting the presentation of the current programme item, the data processor adapts the remaining portion of the schedule. The timeshifter accesses write/read storage 126 in order to perform adjustments on specified programme item material, in accordance with the adapted schedule. The material, adjusted as appropriate, is output as a sequence of programme items at 128 comprising the remaining portion of the entertainment schedule.

By way of example, a detailed presentation of the algorithm for the adaptation of the schedule is given later in the present description.

The data processor may typically be located within a suitable host product such as a TV receiver, and co-operate with the tuner, library server and timeshifter using an appropriate control and signal transfer system including by way of examples Scart/P50 or 1394/HAVi.

The tuner represents a collection of broadcast tuning capabilities available and controllable by the apparatus, including by way of examples terrestrial tuner, satellite tuner, cable tuner and modem. In response to instructions from the data processor acting in accordance with the schedule, the tuner will tune to one or more broadcast channels carrying a programme item selected for the schedule and deliver said item to the timeshifter.

The library server represents a source of pre-recorded and on-demand (including ‘near on-demand’) material available to and controllable by the apparatus. Pre-recorded material comprises programme items stored on appropriate media including by way of examples VHS, DVD, audio cassette, audio CD, MiniDisc and hard diskdrive (HDD). On-demand material includes programme items remotely downloadable via for example broadcast, dial-up and Internet. Near on-demand material is similar to on-demand material except that it may require a short notice period before it is made available, said period being typically less than 30 minutes. In response to instructions from the data processor acting in accordance with the schedule, the library server will arrange to access and deliver to the timeshifter a programme item selected for the schedule.

A programme item may be adjusted by any combination of the following methods for the purpose of adapting the schedule. One method is by altering the start time of a programme item (or remnant thereof) in the adapted remaining portion of the schedule with respect to the timing of said programme item in the original planned schedule. Another method is by adjusting the duration of a programme item (or remnant thereof) to be different with respect to its original duration as received from a broadcast or library source as described herein.

The duration of a programme item may be modified by varying the rate of presentation. In certain circumstances, the rate will be constant during the entire item in a similar fashion to normal speed playback; in other circumstances the rate will vary in a plurality of values during the playback of the item. One example is where the playback is speeded up due to an earlier delay; once the time lost due to the delay has been recovered, the playback rate can revert to normal for the remainder of the programme item.

The duration of a programme item may be modified by editing so as to alter the duration of the edited version compared to the unedited version of the programme item. Editing may be achieved removing portions of the programme item including, by way of example, but not limited to advertising spots, credits and sub-parts. One example is to select a subset of chapters of a DVD title in order to offer a ‘highlights’ version for inclusion within the schedule compared to the full version of the title.

The timeshifter may perform in any combination the adjustments as outlined above. The timeshifter has the capability for the simultaneous replay and storage of a particular programme item (or remnant thereof), for example when performing a short timeshift such as a few minutes. This capability is in addition to conventional timeshifting wherein recording of a programme item completes in its entirety prior to replay of said programme item. The timeshifter in co-operation with its store is therefore capable of simultaneous and independent write and read operations with respect to the same programme item. In addition, the writing and reading operations may be performed at different rates with respect to each other. A preferred method of achieving these capabilities is by means of a hard diskdrive.

In the following description various examples of conditions and corresponding adaptations to the remaining portion of a schedule are given in accordance with the present invention.

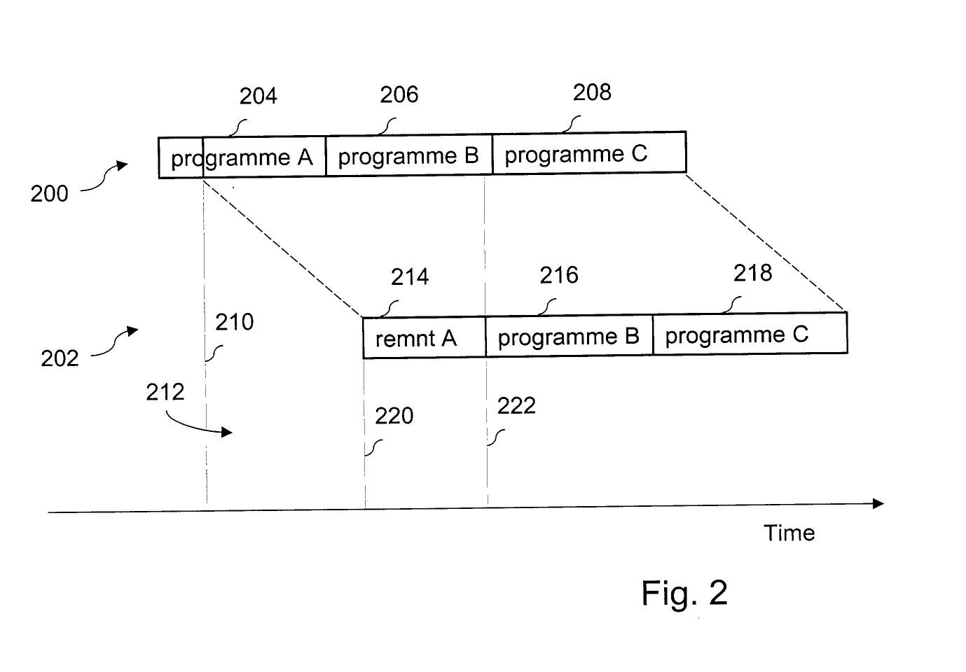

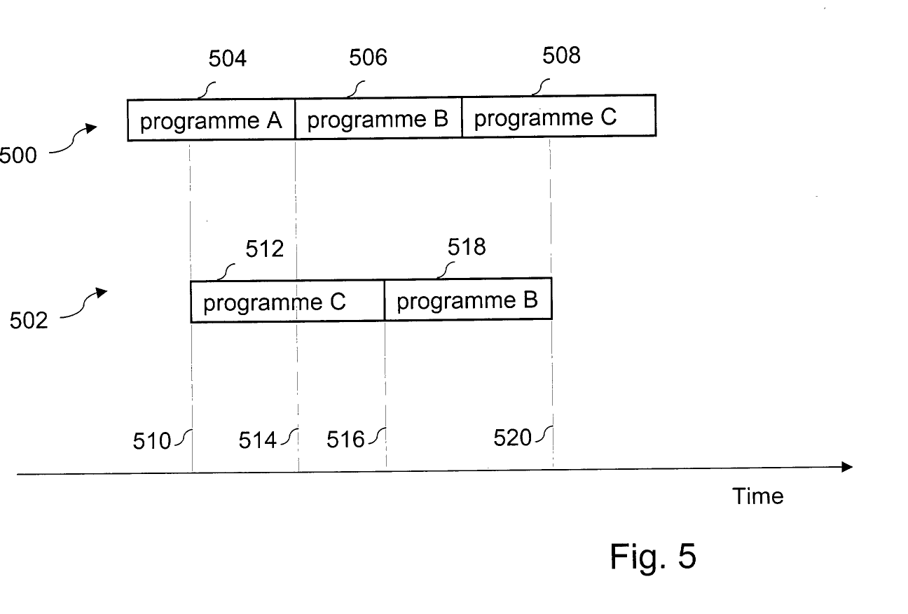

FIG. 2 depicts an example condition where a user interrupts an executing schedule. The original planned schedule 200 comprising programme A 204, programme B 206 and programme C 208 is executing. At a time 210 the user interrupts the presentation of the current programme, programme A 204. The adapter cannot reschedule at this time, since the execution of the schedule has been suspended by the user. However, the adapter does need to take contingency actions to ensure all material following the interruption is captured to permit the remaining portion of the schedule to be available once the interruption is ended. In the case where the current programme (programme A) is a broadcast item, the recording of the remnant of A will be necessary. Later broadcast programmes may also need to be recorded (captured) depending on the duration of the interruption. The interruption ends at 220 having a duration 212. At 220, an adaptation of the schedule must occur, however there is generally a choice available. In this case, the choice is to resume presentation of programme A or to commence presentation of another programme (for example programme B). Selection may be automatic (for example based on context) or perhaps presented to the user. In the example, the adapter automatically resumes programme A. Once the presentation of the remnant of A is completed at 222, a further adaptation is made. In the example, programme B 216 is selected, followed by programme C 218. This appears to be obvious and indeed the adaptation at 222 is then not visible to the user. However, the example also shows that time 222 is close to the start time of programme C, and if programme C is a broadcast item it may be prudent to view it live (that is, avoid recording programme C) and have the option to postpone the viewing of programme B to another time (another schedule). This has the advantages of shortening the delayed schedule and avoiding unnecessary recording. Should the automatic resumption of programme A not have been acceptable to the user, another option to offer the user is to skip the remnant of A, as discussed in the example of FIG. 5 below.

It will be noted that, following a condition occurring, an adaptation of the remaining portion of the schedule is generally performed by the adapter at the end of each subsequent programme item, at least until the condition ends.

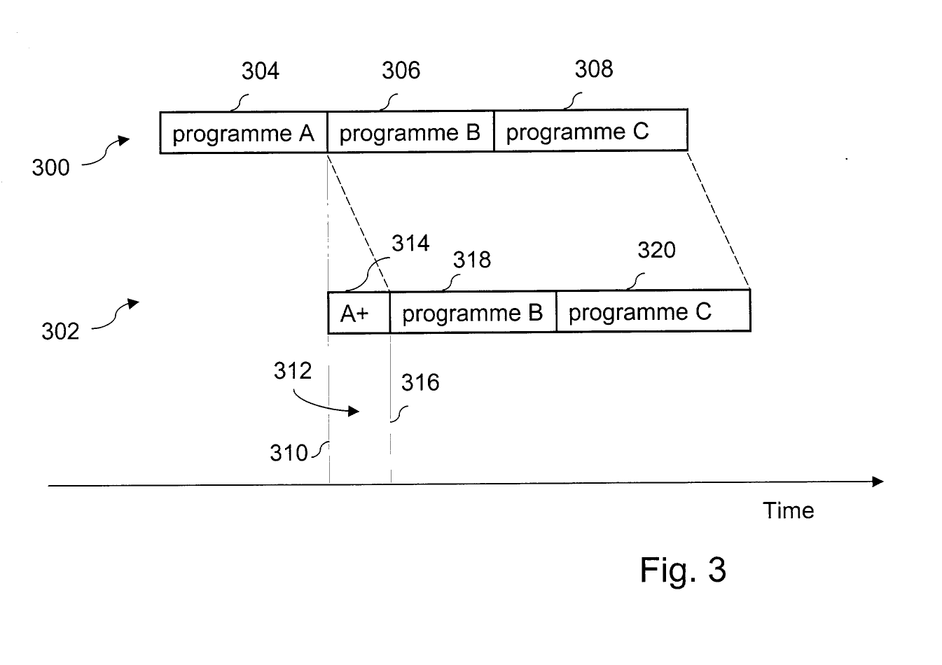

FIG. 3 depicts an example condition where a broadcast item shown live (that is, not timeshifted) in the executing schedule then runs over time. This is a common situation with live events such as sports matches, major news stories and the like. The original planned schedule 300 comprising live broadcast programme A 304, programme B 306 and programme C 308 is executing. At the scheduled end of programme A 310 the broadcaster continues (over runs) programme A by an amount 312. At 310 the adapter could offer the user a choice either to record the overrun or watch it live. The overrun portion of programme A, denoted A+ 314, is automatically presented and ends at time 316 when another adaptation of the schedule occurs, the adapter deciding to follow on with programme B 318 followed by programme C 320. Alternatively, the adapter could re-order the following items to save unnecessary recording or for other reasons, as discussed earlier.

The range of options the adapter has in order to adapt the remaining portion of the schedule depends on the rules it uses and also the mix of broadcast and library items within the remaining portion of the schedule. An approach might be to adapt the schedule to include (where appropriate) the same material as the original schedule whilst also attempting to conclude the schedule on time with respect to the original schedule.

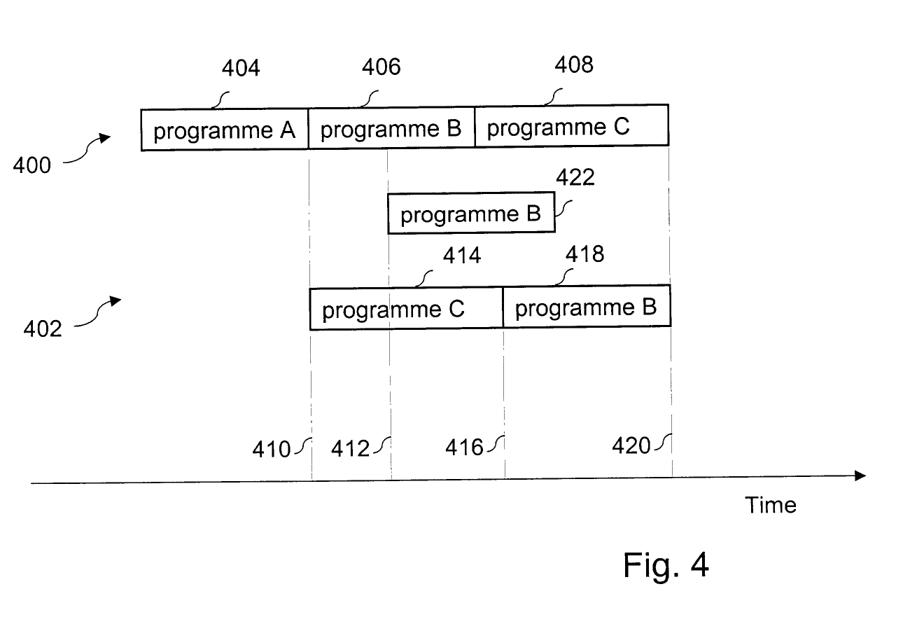

FIG. 4 depicts an example condition where a broadcast programme item is late starting. The original schedule is shown at 400 and comprises programme A 404, broadcast programme B 406 and library programme C 408. At start time of programme B 410 the system detects that programme B will be late starting. The system then performs an adaptation of the schedule, in the example programme C is a library item and so can be promoted (that is, brought forward in time) to be presented at 414 in place of programme B. During the presentation of programme C, the adapter program monitors for the broadcast of programme B 422, which it detects at 412 and instructs the system to record. When programme C ends 416, the system performs a further adaptation of the schedule and plays out programme B 418. The schedule concludes on time (with respect to the original schedule) at 420. Of course, in the above, if it were not possible to advance the presentation of programme C then the result would be a gap in the adapted schedule—this could be left; alternatively, the gap could be filled with one or more substitute programmes by means of some type of schedule creation process separate to the method of the present invention.

FIG. 5 depicts an example condition where the user decides to skip the remainder of the current programme. The original schedule is shown at 500 and comprises programme A 504, broadcast programme B 506 and library programme C 508. Part way (at 510) through the presentation of current programme A the user decides to skip the remainder of programme A. Consequently, the system performs an adaptation of the schedule at 510 and promotes library programme C 512 to be presented in place of the remainder of programme A. While programme C is being presented, the system detects the start 514 of broadcast programme B which it then records. When programme C ends 516, the system then performs a further adaptation of the schedule and plays out programme B 518. The schedule concludes early (with respect to the original schedule) at 520. As with the previous example, other choices must be made where programme C is a broadcast item.

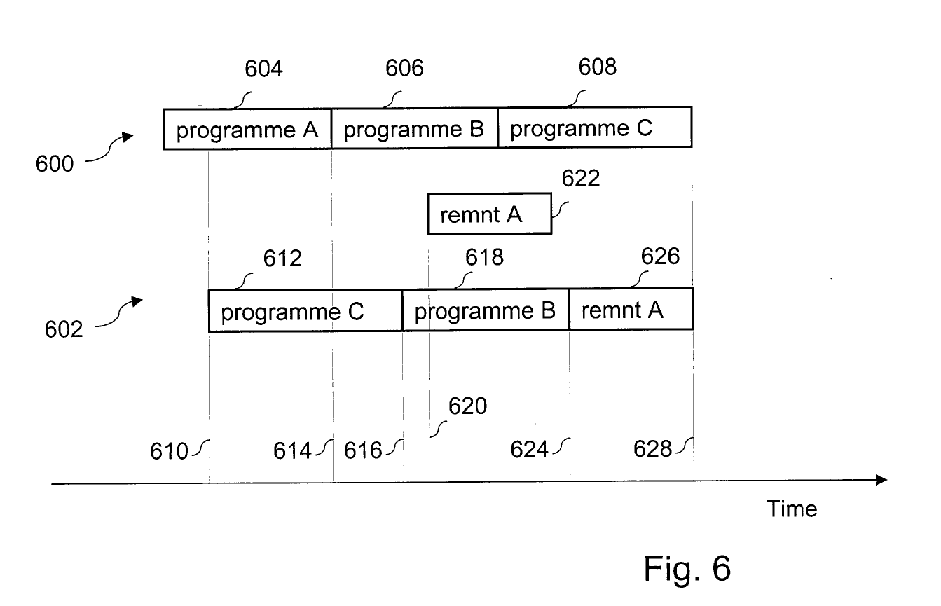

FIG. 6 depicts an example condition where the broadcaster interrupts the current programme item. The original schedule is shown at 600 and comprises broadcast programme A 604, broadcast programme B 606 and library programme C 608. Part way (at 610) through the presentation (broadcast) of current programme A the broadcaster interrupts the presentation. Since the interruption may last some time, the system performs an adaptation of the schedule at 610 and promotes library programme C 612 to be presented in place of the remainder of programme A. While programme C is being presented, the system monitors for the resumption of programme A by the broadcaster and also for the following scheduled programme B. At 614, the system records programme B for inclusion some time later in the schedule. At the end of programme C 616, the system performs an adaptation of the schedule and decides to present programme B 618 since the remainder of programme A has still to be broadcast. While programme B is being presented, the system again monitors for the resumption of programme A by the broadcaster and detects this at 620 and records the remnant of programme A 622. At the end of programme B, the system performs an adaptation of the schedule and decides to present the remnant of programme A 626. The schedule concludes on time (with respect to the original schedule) at 628.

The scenarios depicted by FIGS. 2-6 and described above are selected illustrations of the broad capability of the method disclosed by the present invention.

There now follows a discussion of the schedule adaptation algorithm as embodied in the apparatus described above and illustrated in FIG. 1.

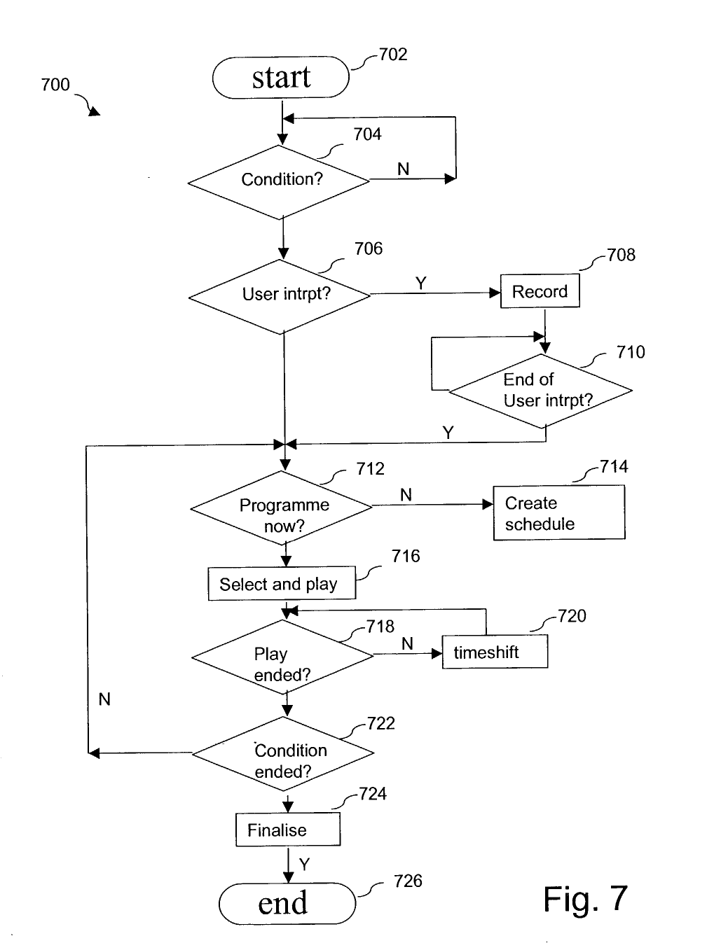

FIG. 7 depicts a flowchart of the adaptation algorithm 700. The schedule is currently executing. The algorithm starts at 702 and tests at 704 for a condition to occur. When a condition occurs, the “user interruption” condition is tested for at 706. This condition is treated as a special case since the only action that can be taken is to conserve (timeshift) the currently presented (and possibly following) programme material by recording at 708 pending an ending of the interruption at 710 whereupon the normal adaptation process can resume. At 712 a test is made to determine, within the remaining portion of the schedule, programme item material that is available for presentation immediately. If there is none available, then an option is to create a new schedule at 714 using a process separate from that of the present invention. Of the programme items available at 712, the adapter selects an item and commences presentation at 716. At 718, while the current item plays, the adapter reviews the original planned schedule and records (timeshifts) broadcast material that cannot be presented according to the original schedule (due to the current item being presented), in readiness for including such material later in the (adapted) schedule. When the current presented item ends at 722, the adapter tests to establish if the condition still exists; if true, then the loop 712, 716, 718, 722 is repeated. Otherwise, the adapter performs a final adaptation of the remaining portion of the schedule at 724 and the algorithm ends at 726.

The foregoing algorithm is presented by way of example only and represents one of a range of algorithms that can readily be defined by a person skilled in the art to exploit the advantages of the method as disclosed in the present invention.

In the description above and with reference to FIG. 1, a method and apparatus are described for adapting an entertainment schedule comprising a plurality of programme items. During the execution of the schedule, unforeseen conditions as represented by conditions data 106 may occur causing the data processor 101 to adapt the remaining portion of the schedule. The data processor co-operates with a tuner 118, a library server 120 and a timeshifter 122 to execute the adapted schedule. The timeshifter adjusts specified programme items received from the tuner 118 and library server 120 in conjunction with timeshifter storage 126 thereby ensuring a sequence of programme items are output at 128, the sequence comprising substantially the same material as contained in the original schedule prior to the occurrence of the condition.

1. A method for adapting an entertainment schedule which is executing, the schedule comprising a plurality of programme items, the method being supported by means for timeshifting, wherein when a condition occurs which affects the presentation of a currently presented programme item, the remaining portion of the schedule is adapted by timeshifting at least one programme item so as to comprise substantially the same material as present in the schedule prior to the occurrance of the condition.

2. A method as claimed in claim 1 wherein the adaption of the remaining portion of the schedule provides contiguity in presentation of programme items.

3. A method as claimed in claim 1 wherein timeshifting comprises an adjustment to the starting time of the programme item.

4. A method as claimed in claim 3 wherein timeshifting is performed at least partially in response to auxiliary data associated with the programme item.

5. A method as claimed in claim 1 wherein the schedule comprises broadcast and pre-stored programme items.

6. A method as claimed in claim 1 wherein at least one programme item comprises a pre-determined period during which no presentation is made to a user.

7. A method as claimed in claim 2 wherein at least one programme item comprises a pre-determined period during which no presentation is made to a user.

8. A method as claimed in claim 1 wherein the adapted remaining portion of the schedule includes at least a programme item with a start time and an end time which are the same as those of the same programme item prior to the occurrance of the condition.

9. A method as claimed in claim 2 wherein the adapted remaining portion of the schedule includes at least a programme item with a start time and an end time which are the same as those of the same programme item prior to the occurrance of the condition.

10. A method as claimed in claim 1 wherein the effect of the condition is to delay the end time of the currently presented programme item.

11. A method as claimed in claim 1 wherein the effect of the condition is to bring forward the end time of the currently presented programme item.

12. A method as claimed in claim 1 wherein the remaining portion of the schedule is adapted so as to complete as early as possible.

13. A method as claimed in claim 2 wherein the remaining portion of the schedule is adapted so as to complete as early as possible.

14. A method as claimed in claim 1 wherein the remaining portion of the schedule is adapted automatically in accordance with received user preferences.

15. An apparatus arranged to adapt an entertainment schedule which is executing and which comprises a plurality of programme items, the portion of the schedule remaining to be executed being adaptable by the apparatus to accommodate changes due to a condition affecting the presentation of a currently presented programme item, the apparatus comprising:
a data processor comprising CPU, storage for the schedule adaptation program and the schedule, operable to process data representing the condition, to adapt the schedule and to store the adapted schedule;
a source of programme material arranged to capture and deliver programme items to a timeshifter in response to the adapted schedule; and
the timeshifter co-operating with the data processor and arranged to receive the programme items, to adjust the programme items by timeshifting and to output the programme items in a sequence in accordance with the adapted schedule.

16. An apparatus as claimed in claim 15 wherein the source of programme material is a tuner operable to receive broadcast programme items.

17. An apparatus as claimed in claim 15 wherein the source of programme material is a library server operable to access pre-stored programme items.

18. An apparatus as claimed in claim 15 wherein the timeshifter is arranged to co-operate with a store to perform simultaneous write/read operations with respect to a programme item.

19. An apparatus as claimed in claim 15 wherein the timeshifter is arranged to perform timeshifting of a programme item at least partially in response to programme item identification information associated with said programme item.

20. A software utility configured for carrying out the method steps as claimed in claim 1.

21. A software utility configured for carrying out the method steps as claimed in claim 2.

22. An apparatus including a data processor as claimed in claim 15, said data processor being directed in its operations by a software utility as claimed in claim 20.

23. An apparatus including a data processor as claimed in claim 15, said data processor being directed in its operations by a software utility as claimed in claim 21.
